(19) United States
(12) Patent Application Publication
(10) Pub. No.: US 2016/0316805 A1
(43) Pub. Date: Nov. 3, 2016

(54) ARRAY OF AGE-TAILORED NUTRITIONAL FORMULAE WITH OPTIMUM MINERAL NUTRIENT CONTENT

(71) Applicant: NESTEC S.A., Vevey (CH)

(72) Inventors: Carlos Antonio De Castro, Geneva (CH); Yongcheng Liao, Beijing (CN); Junkuan Wang, Beijing (CN); Ying Xia, Beijing (CN); Celia Ning, Beijing (CN)

(21) Appl. No.: 15/103,939

(22) PCT Filed: Sep. 3, 2014
(86) PCT No.: PCT/EP2014/068677

§ 371 Date: Jun. 13, 2016

(30) Foreign Application Priority Data
Dec. 12, 2013 (CN) PCT/CN2013/089272

(51) Int. Cl. A23L 33/16; A23L 33/135; A23L 33/155; A23L 33/19; A23L 33/15; A23L 33/00; A23L 33/115

(52) U.S. Cl. CPC A23L 33/16; A23L 33/40; A23L 33/30; A23L 33/135; A23L 33/115; A23L 33/19; A23L 33/15; A23L 33/155; A23V 2002/00; A23Y 2300/49; A23Y 2300/55

(57) ABSTRACT

This invention relates to an age tailored nutrition system for infants. In particular, the invention relates to an array of infant formulae for providing an age-tailored nutrition system to an infant, comprising a first infant formula, a second infant formula and an optional third infant formula, wherein (a) said first infant formula being designed to meet the nutritional requirements of an infant from birth to two months, (b) said second infant formula being designed to meet the nutritional requirements of an infant from two months to six months, and (c) said optional third infant formula being designed to meet the nutritional requirements of an infant from six months to twelve months; wherein each of said first, second and third infant formulae comprises suitable amounts of mineral nutrients selected from the group consisting of calcium, iodine, phosphorus, potassium, sodium, copper and zinc, wherein the content of at least one of said mineral nutrients in the second infant formula is lower than in the first infant formula, and the content of said at least one mineral nutrient in the optional third infant formula is lower than in the second infant formula.

### FIELD OF THE INVENTION

This invention relates to an age tailored nutrition system for infants. In particular, the invention relates to an array of infant formulae for providing an age-tailored nutrition system to an infant, comprising a first infant formula, a second infant formula and an optional third infant formula.

### BACKGROUND OF THE INVENTION

Research into the components of human milk has been going on for many years and is by no means complete even now. However, it has been known for some time that the composition of human milk changes appreciably with duration of lactation.

Mother's milk is recommended for all infants. However, in some cases breast feeding is inadequate or unsuccessful for medical reasons or the mother chooses not to breast feed. Infant formulae have been developed for these situations. Conventional infant formulae fall into two categories, the first stage formulae for infants from the age of birth to 6 months and which provide complete nutrition for this age group and the second stage formulae for infants from the age of six months to twelve months which are fed to the infants in combination with increasing amounts of other foods such as infant cereals and puréed fruits, vegetables and other foodstuffs as the process of weaning progresses.

The composition of the human milk varies naturally according to the age of the infant. Such variations include not only organic nutrients but also mineral nutrients. For example, according to our statistical report of breast milk of Chinese lactating mothers (which is discussed in detail below), the content of mineral nutrients in breast milk varies during breastfeeding according to the age of the infant, especially in the period of from birth to six months.

However, up to now, the content of mineral nutrients is generally fixed in a first stage formula for infants from the age of birth to 6 months or in a second stage formula for infants from the age of six months to twelve months.

It is therefore important to develop infant formulae which replicate human breast milk as far as possible in terms of nutritional properties.

Human breast milk is indeed the golden standard as for the composition of infant formula. Hence its composition should try to be mimicked to the extent possible for each age of the infant.

However the composition of infant formula is a complex matter where the balance of the many nutrients (in particular the minerals) is interrelated and crucial. Unbalancement of one or more nutrients cannot tolerated nor risked.

Therefore, the invention aims at ensuring an optimal mineral nutrient content in infant formulae to improve body development of an infant.

It is also an object of the invention to follow the nutritional evolution curve of human breast milk at all ages.

It is an overall object of the invention to provide the infants with a most adapted nutrition at each age, especially during the first months of life when the growth, and the development of all the body functions and metabolic systems are very crucial.

### SUMMARY OF THE INVENTION

In order to mimic human breast milk, the inventors carried out an investigation in China to characterize the nutrients composition of Chinese mother milk. The results of some mineral nutrients in the statistical report of breast milk of Chinese lactating mothers are briefly provided below.

Study Design

This is an observational, cross sectional, multi-center study aiming at evaluating nutrients composition of breast milk and nutrition intake of Chinese lactating mothers in 3 cities in China.

Study Population

Number of Subjects

Total 540 healthy subjects were enrolled, allowing a drop-out rate of 10 percent.

They were comprised of:
480 Lactating mothers only in 3 cities (Beijing, Suzhou and Guangzhou)
30 mothers per city for each of the 5 time points (5-11 days, 1 month, 2 months, 4 months and 8 months)

Inclusion/Exclusion Criteria
Inclusion: Healthy Chinese lactating mothers without history of acute and chronic diseases; exclusively breast feeding mothers during 4 months after delivery were enrolled.
Exclusion: Chinese lactating mothers having history of psychopath tendencies and having no dietary memory.

Results

Summary Statistics of Minerals

| | | | | | |
|---|---|---|---|---|---|
| months | N | Min | Mean | SD | Max |

Calcium(mg/kg)

| | | | | | |
|---|---|---|---|---|---|
| 0 | 90 | 192.00 | 303.32 | 52.45 | 419.00 |
| 1 | 90 | 151.00 | 293.16 | 46.27 | 397.00 |
| 2 | 90 | 206.00 | 309.27 | 42.99 | 432.00 |
| 4 | 90 | 198.00 | 287.44 | 39.99 | 406.00 |
| 8 | 90 | 150.00 | 267.59 | 43.43 | 462.00 |

Copper(mg/kg)

| | | | | | |
|---|---|---|---|---|---|
| 0 | 90 | 0.16 | 0.56 | 0.15 | 0.93 |
| 1 | 89 | 0.26 | 0.49 | 0.14 | 1.10 |
| 2 | 90 | 0.15 | 0.35 | 0.09 | 0.59 |
| 4 | 90 | 0.13 | 0.31 | 0.07 | 0.47 |
| 8 | 86 | 0.11 | 0.28 | 0.09 | 0.64 |

Iodine(μg/kg)

| | | | | | |
|---|---|---|---|---|---|
| 0 | 89 | 53.00 | 293.63 | 157.29 | 946.00 |
| 1 | 89 | 62.00 | 223.35 | 121.47 | 618.00 |
| 2 | 85 | 51.00 | 188.09 | 91.33 | 680.00 |
| 4 | 88 | 51.00 | 175.28 | 75.99 | 484.00 |
| 8 | 90 | 59.00 | 185.96 | 96.35 | 594.00 |

Phosphorus(mg/kg)

| | | | | | |
|---|---|---|---|---|---|
| 0 | 90 | 66.00 | 143.79 | 33.64 | 214.00 |
| 1 | 90 | 73.00 | 147.88 | 24.64 | 228.00 |
| 2 | 90 | 93.00 | 136.08 | 19.48 | 182.00 |
| 4 | 90 | 88.00 | 118.02 | 18.39 | 192.00 |
| 8 | 90 | 35.00 | 113.58 | 19.45 | 198.00 |

Potassium(mg/kg)

| | | | | | |
|---|---|---|---|---|---|
| 0 | 90 | 438.00 | 665.89 | 111.00 | 1001.00 |
| 1 | 90 | 423.00 | 600.34 | 79.03 | 832.00 |
| 2 | 90 | 375.00 | 537.10 | 63.30 | 715.00 |
| 4 | 90 | 352.00 | 489.12 | 61.36 | 649.00 |
| 8 | 90 | 356.00 | 459.26 | 47.94 | 614.00 |

Sodium(mg/kg)

| | | | | | |
|---|---|---|---|---|---|
| 0 | 89 | 87.0 | 360.3 | 225.7 | 1220.0 |
| 1 | 89 | 97.0 | 230.8 | 190.9 | 1280.0 |
| 2 | 90 | 60.0 | 140.3 | 67.5 | 510.0 |
| 4 | 90 | 41.0 | 130.3 | 68.8 | 45.00 |
| 8 | 90 | 39.0 | 120.1 | 92.4 | 810.0 |

Zinc(mg/kg)

| | | | | | |
|---|---|---|---|---|---|
| 0 | 90 | 0.89 | 3.87 | 1.52 | 9.90 |
| 1 | 90 | 0.91 | 2.85 | 1.16 | 7.30 |
| 2 | 90 | 0.66 | 1.98 | 0.68 | 4.10 |
| 4 | 89 | 0.52 | 1.47 | 0.61 | 3.50 |
| 8 | 86 | 0.57 | 1.25 | 0.50 | 2.90 |

N means the number of non-missing values.

According to above results, the inventors performed statistical analysis and surprisingly found the contents of many mineral nutrients in breast milk gradually decrease in the first 12 months, especially in the first 6 months. Moreover, the ratio of calcium and phosphorus gradually increase in this period. Based on these unexpected findings, the present invention provides modified contents of mineral nutrients in infant formulae to improve nutritional condition of an infant.

In one aspect, the invention applies to the general population. In another aspect the invention can particularly apply in groups of population having common genetic origins and/or ethnic origins and/or common dietary habits such as a Chinese, Asian, Indian, and/or Mongoloid populations. In particular in light of the results reported hereby the Chinese population is of specific interest for the invention.

In a first aspect, the present invention relates to an array of infant formulae for providing an age-tailored nutrition system to an infant, comprising a first infant formula, a second infant formula and an optional third infant formula, wherein

(a) said first infant formula being designed to meet the nutritional requirements of an infant from birth to two months,
(b) said second infant formula being designed to meet the nutritional requirements of an infant from two months to six months, and
(c) said optional third infant formula being designed to meet the nutritional requirements of an infant from six months to twelve months;
wherein each of said first, second and third infant formulae comprises suitable amounts of mineral nutrients selected from the group consisting of calcium, iodine, phosphorus, potassium, sodium, copper and zinc,
wherein the content of at least one of said mineral nutrients in the second infant formula is lower than in the first infant formula, and the content of said at least one mineral nutrient in the optional third infant formula is lower than in the second infant formula.

In a second aspect, the invention relates to a method of providing nutrition to an infant in the first twelve months of life, comprising:

(i) feeding to the infant for initial two months of life the first infant formula as described above,
(ii) feeding to the infant for the remainder of the first six months of life the second infant formula as described above, and optionally
(iii) feeding to the infant for the remainder of the first twelve months of life the third infant formula as described above.

In a third aspect, the use of the array of infant formulae of the present invention for improving the nutritional condition of an infant from birth to twelve months is also part of the present invention.

In another aspect, use of the array of infant formulae of the present invention for preparation of a kit for improving the nutritional condition of an infant from birth to twelve months is provided.

In a preferred aspect, the array of infant formulae of the present invention wherein the ratio of calcium and phosphorus in the first infant formulae is lower than in the second infant formula is provided.

### DETAILED DESCRIPTION OF THE INVENTION

In the present specification, the following words are given a definition that must be taken into account when reading and interpreting the description, examples and claims.

The term “infants” means children under the age of 12 months.

The term “infant formula” means foodstuffs intended for particular nutritional use by infants and satisfying by themselves the nutritional requirements of this category of persons. It has to be understood that infants can be fed solely with infant formula, or that the infant formula can be used by the carer as a complement of human milk.

In one aspect, the present invention relates to an array of infant formulae for providing an age-tailored nutrition system to an infant, comprising a first infant formula, a second infant formula and an optional third infant formula, wherein

(a) said first infant formula being designed to meet the nutritional requirements of an infant from birth to two months,
(b) said second infant formula being designed to meet the nutritional requirements of an infant from two months to six months, and
(c) said optional third infant formula being designed to meet the nutritional requirements of an infant from six months to twelve months;
wherein each of said first, second and third infant formulae comprises suitable amounts of mineral nutrients selected from the group consisting of calcium, iodine, phosphorus, potassium, sodium, copper and zinc,
wherein the content of at least one of said mineral nutrients in the second infant formula is lower than in the first infant formula, and the content of said at least one mineral nutrient in the optional third infant formula is lower than in the second infant formula.

In a preferred embodiment, the present invention provides an array of infant formulae as described above, wherein the contents of at least two, preferably at least three, more preferably at least four, particularly preferably at least five of said mineral nutrients in the second infant formula are lower than in the first infant formula, and the contents of said at least two, preferably at least three, more preferably at least four, particularly preferably at least five of said mineral nutrients in the optional third infant formula are lower than in the second infant formula.

In a preferred embodiment, said at least two mineral nutrients are iodine and phosphorus. In another preferred embodiment, said at least two mineral nutrients are iodine and potassium. In another preferred embodiment, said at least two mineral nutrients are iodine and sodium. In another preferred embodiment, said at least two mineral nutrients are iodine and copper. In another preferred embodiment, said at least two mineral nutrients are iodine and zinc. In another preferred embodiment, said at least two mineral nutrients are iodine and calcium.

In a preferred embodiment, said at least two mineral nutrients are phosphorus and potassium. In another preferred embodiment, said at least two mineral nutrients are phosphorus and sodium. In another preferred embodiment, said at least two mineral nutrients are phosphorus and copper. In another preferred embodiment, said at least two mineral nutrients are phosphorus and zinc. In another preferred embodiment, said at least two mineral nutrients are phosphorus and calcium.

In a preferred embodiment, said at least two mineral nutrients are potassium and sodium. In another preferred embodiment, said at least two mineral nutrients are potassium and copper. In another preferred embodiment, said at least two mineral nutrients are potassium and zinc. In another preferred embodiment, said at least two mineral nutrients are potassium and calcium.

In a preferred embodiment, said at least two mineral nutrients are sodium and copper. In another preferred embodiment, said at least two mineral nutrients are sodium and zinc. In another preferred embodiment, said at least two mineral nutrients are sodium and calcium.

In a preferred embodiment, said at least two mineral nutrients are copper and zinc. In another preferred embodiment, said at least two mineral nutrients are copper and calcium. In another preferred embodiment, said at least two mineral nutrients are zinc and calcium.

In a preferred embodiment, said at least three mineral nutrients are iodine, phosphorus and potassium. In another preferred embodiment, said at least three mineral nutrients are iodine, phosphorus and sodium. In another preferred embodiment, said at least three mineral nutrients are iodine, phosphorus and copper. In another preferred embodiment, said at least three mineral nutrients are iodine, phosphorus and zinc. In another preferred embodiment, said at least three mineral nutrients are iodine, phosphorus and calcium.

In a preferred embodiment, said at least three mineral nutrients are iodine, potassium and sodium. In another preferred embodiment, said at least three mineral nutrients are iodine, potassium and copper. In another preferred embodiment, said at least three mineral nutrients are iodine, potassium and zinc. In another preferred embodiment, said at least three mineral nutrients are iodine, potassium and calcium.

In a preferred embodiment, said at least three mineral nutrients are iodine, sodium and copper. In another preferred embodiment, said at least three mineral nutrients are iodine, sodium and zinc. In another preferred embodiment, said at least three mineral nutrients are iodine, sodium and calcium.

In a preferred embodiment, said at least three mineral nutrients are iodine, copper and zinc. In another preferred embodiment, said at least three mineral nutrients are iodine, copper and calcium. In another preferred embodiment, said at least three mineral nutrients are iodine, zinc and calcium.

In a preferred embodiment, said at least three mineral nutrients are phosphorus, potassium and sodium. In another preferred embodiment, said at least three mineral nutrients are phosphorus, potassium and copper. In another preferred embodiment, said at least three mineral nutrients are phosphorus, potassium and zinc. In another preferred embodiment, said at least three mineral nutrients are phosphorus, potassium and calcium.

In a preferred embodiment, said at least three mineral nutrients are phosphorus, sodium and copper. In another preferred embodiment, said at least three mineral nutrients are phosphorus, sodium and zinc. In another preferred embodiment, said at least three mineral nutrients are phosphorus, sodium and calcium.

In a preferred embodiment, said at least three mineral nutrients are phosphorus, copper and zinc. In another preferred embodiment, said at least three mineral nutrients are phosphorus, copper and calcium. In another preferred embodiment, said at least three mineral nutrients are phosphorus, zinc and calcium.

In a preferred embodiment, said at least three mineral nutrients are potassium, sodium and copper. In another preferred embodiment, said at least three mineral nutrients are potassium, sodium and zinc. In another preferred embodiment, said at least three mineral nutrients are potassium, sodium and calcium.

In a preferred embodiment, said at least three mineral nutrients are potassium, copper and zinc. In another preferred embodiment, said at least three mineral nutrients are potassium, copper and calcium.

In a preferred embodiment, said at least three mineral nutrients are sodium, copper and zinc. In another preferred embodiment, said at least three mineral nutrients are sodium, copper and calcium. In another preferred embodiment, said at least three mineral nutrients are sodium, zinc and calcium.

In a preferred embodiment, said at least three mineral nutrients are copper, zinc and calcium.

In a particularly preferred embodiment, the contents of iodine, phosphorus, potassium, sodium, copper and zinc in the second infant formula are lower than in the first infant formula, and the contents of said mineral nutrients in the optional third infant formula are lower than in the second infant formula.

In a very particularly preferred embodiment, the contents of calcium, iodine, phosphorus, potassium, sodium, copper and zinc in the second infant formula are lower than in the first infant formula, and the contents of said mineral nutrients in the optional third infant formula are lower than in the second infant formula.

In any of above embodiments, the content of iodine in the first infant formula is from 50.0 μg/100 kcal to 16.5 μg/100 kcal, preferably from 26.0 μg/100 kcal to 16.5 μg/100 kcal, the content of iodine in the second infant formula is from 16.5 μg/100 kcal to 14.0 μg/100 kcal, and the content of iodine in the optional third infant formula is lower than 14.0 μg/100 kcal.

In any of above embodiments, the content of phosphorus in the first infant formula is from 70 mg/100 kcal to 42 mg/100 kcal, preferably from 50 mg/100 kcal to 42 mg/100 kcal, the content of phosphorus in the second infant formula is from 42 mg/100 kcal to 38 mg/100 kcal, and the content of phosphorus in the optional third infant formula is lower than 38 mg/100 kcal.

In any of above embodiments, the content of potassium in the first infant formula is from 170 mg/100 kcal to 85 mg/100 kcal, preferably from 115 mg/100 kcal to 85 mg/100 kcal, the content of potassium in the second infant formula is from 85 mg/100 kcal to 80 mg/100 kcal, and the content of potassium in the optional third infant formula is lower than 80 mg/100 kcal.

In any of above embodiments, the content of sodium in the first infant formula is from 58 mg/100 kcal to 25 mg/100 kcal, preferably from 50 mg/100 kcal to 25 mg/100 kcal, the content of sodium in the second infant formula is from 25 mg/100 kcal to 22 mg/100 kcal, and the content of sodium in the optional third infant formula is lower than 22 mg/100 kcal.

In any of above embodiments, the content of copper in the first infant formula is from 120 μg/100 kcal to 62 μg/100 kcal, preferably from 110 μg/100 kcal to 62 μg/100 kcal, the content of copper in the second infant formula is from 62 μg/100 kcal to 55 μg/100 kcal, and the content of copper in the optional third infant formula is lower than 55 μg/100 kcal.

In any of above embodiments, the content of zinc in the first infant formula is from 1.5 mg/100 kcal to 0.7 mg/100 kcal, the content of zinc in the second infant formula is from 0.7 mg/100 kcal to 0.6 mg/100 kcal, and the content of zinc in the optional third infant formula is lower than 0.6 mg/100 kcal.

In any of above embodiments, the content of calcium in the first infant formula is from 140 mg/100 kcal to 98 mg/100 kcal, preferably from 105 mg/100 kcal to 98 mg/100 kcal, the content of calcium in the second infant formula is from 98 mg/100 kcal to 95 mg/100 kcal, and the content of calcium in the optional third infant formula is lower than 95 mg/100 kcal.

In any of above embodiments, the ratio of calcium and phosphorus in the first infant formulae is preferably lower than in the second infant formula.

In any of above embodiments, the ratio of calcium and phosphorus in the first infant formula is preferably from 2.0:1 to 2.2:1, more preferably from 2.1:1 to 2.2:1.

In any of above embodiments, the ratio of calcium and phosphorus in the second infant formulae is preferably from 2.2:1 to 2.4:1.

In any of above embodiments, the ratio of calcium and phosphorus in the third infant formula is preferably from 2.4:1 to 2.5:1.

In a further aspect, the present invention provides the array of infant formulae as described above for use in improving the nutritional condition of an infant from birth to twelve months.

In a further aspect, the present invention provides the array of infant formulae as described above for use in improving the nutritional condition of an infant, wherein said infant is from birth to six months.

In a further aspect, the present invention provides use of the array of infant formulae as described above for preparation of a kit for improving the nutritional condition of an infant from birth to twelve months.

In a further aspect, the present invention provides the use of the array of infant formulae as described above for preparation of a kit for improving the nutritional condition of an infant wherein said infant is from birth to six months.

In another aspect, the present invention provides a method of providing nutrition to an infant in the first six months of life, comprising:

(i) feeding to the infant for initial two months of life the first infant formula as described above, and
(ii) feeding to the infant for the remainder of the first six months of life the second infant formula as described above.

In another aspect, the present invention provides a method of providing nutrition to an infant in the first twelve months of life, comprising:

(i) feeding to the infant for initial two months of life the first infant formula as described above,
(ii) feeding to the infant for the remainder of the first six months of life the second infant formula as described above, and
(iii) feeding to the infant for the remainder of the first twelve months of life the third infant formula as described above.

In the array of the present invention, any of the first, second or third infant formula may comprise other conventional nutritional ingredients such as carbohydrates, lipids, proteins, prebiotics, probiotics, vitamins, or the like. The sources and contents of these ingredients in the infant formulae are well known by a skilled person in the field to which the present invention belongs.

In a preferred embodiment, the infant formulae may further comprise long-chain polyunsaturated fatty acids (LC-PUFA). These have been linked to benefits in infant/young child development. Preferably, the LC-PUFA are selected from docosahexaenoic acid (DHA), arachidonic acid (ARA), eicosapentaenoic acid (EPA) or any mixtures thereof. Most preferably, the first, second and third nutritional compositions comprise a mixture of docosahexaenoic acid (DHA) and arachidonic acid (ARA). Most preferably, the fourth composition comprises docosahexaenoic acid (DHA).

The origin of DHA or ARA may be of importance in the context of the present invention as DHA and/or ARA from fish oil may have a different effect compared to microbial DHA or ARA. The sustained fat intake of the present invention may compensate for that effect.

Any of the infant formulae of the invention may also comprise medium chain triglycerides and/or milk fat globule membranes (MFGM).

In the array of the present invention, any of the first, second or third infant formula may further comprise carbohydrates. Suitable carbohydrate sources include lactose, saccharose, maltodextrin, starch and mixtures thereof. In a preferred embodiment, the first, second and third infant formulae comprise lactose. Preferably, the amount of lactose in the first, second or third infant formula is between 9.5 and 12 g/100 kcal, preferably between 10 and 11 g/100 kcal.

The first, second and third formulae may further comprise proteins such as intact or hydrolysed protein, proteins associated with milk fat globule membrane (MFGM), casein, whey, soy protein, or any mixtures thereof. In a preferred embodiment, the first infant formula has a protein source comprising whey and optionally casein proteins and has a whey:casein ratio between 100:0 and 60:40 and a protein content between 2.0 and 3.0 g protein/100 kcal, and the second infant formula has a protein source comprising whey and casein proteins and has a whey:casein ratio between 70:30 and 50:50 and a protein content between 1.7 and 2.1 g protein/100 kcal with the proviso that either the protein content or the whey:casein ratio of the second formula or both is/are lower than for the first formula.

Optionally, the first, second and third formulae may comprise vitamins selected from vitamin A, beta-carotene, vitamin D, vitamin E, vitamin K1, vitamin C, vitamin B1, vitamin B2, niacin, vitamin B6, folic acid, pantothenic acid, vitamin B12, biotin, choline, inositol, taurine, carnitine, or any mixtures thereof.

In a preferred embodiment, any of the first, second or third formula may comprise lactoferrin.

Additionally, any of the first, second or third formulae may comprise prebiotics. If present, the prebiotic is preferably present in the formulae in an amount 1 to 20 wt %, preferably 2 to 15 wt % on a dry matter basis.

A prebiotic is a non-digestible food ingredient that beneficially affects the host by selectively stimulating the growth and/or activity of one or a limited number of bacteria in the colon, and thus improves host health. Such ingredients are non-digestible in the sense that they are not broken down and absorbed in the stomach or small intestine and thus pass intact to the colon where they are selectively fermented by the beneficial bacteria. Examples of prebiotics include certain oligosaccharides, such as fructooligosaccharides (FOS) and galactooligosaccharides (GOS). A combination of prebiotics may be used such as 90% GOS with 10% short chain fructo-oligosaccharides such as the product sold under the trade mark Raftilose® or 10% inulin such as the product sold under the trade mark Raftiline®.

A particularly preferred prebiotic is a mixture of galacto-oligosaccharide(s), N-acetylated oligosaccharide(s) and sialylated oligosaccharide(s) in which the N-acetylated oligosaccharide(s) comprise 0.5 to 4.0% of the oligosaccharide mixture, the galacto-oligosaccharide(s) comprise 92.0 to 98.5% of the oligosaccharide mixture and the sialylated oligosaccharide(s) comprise 1.0 to 4.0% of the oligosaccharide mixture. This mixture is hereinafter referred to as “CMOS-GOS”.

Preferably, any of the first, second or third infant formulae of the invention contain from 2.5 to 15.0 wt % CMOS-GOS on a dry matter basis with the proviso that the composition comprises at least 0.02 wt % of an N-acetylated oligosaccharide, at least 2.0 wt % of a galacto-oligosaccharide and at least 0.04 wt % of a sialylated oligosaccharide.

Suitable N-acetylated oligosaccharides include GalNAcαl,3Galβl,4Glc and Galβl,6GalNAcαl,3Galβl,4Glc. The N-acetylated oligosaccharides may be prepared by the action of glucosaminidase and/or galactosaminidase on N-acetyl-glucose and/or N-acetyl galactose. Equally, N-acetyl-galactosyl transferases and/or N-acetyl-glycosyl transferases may be used for this purpose. The N-acetylated oligosaccharides may also be produced by fermentation technology using respective enzymes (recombinant or natural) and/or microbial fermentation. In the latter case the microbes may either express their natural enzymes and substrates or may be engineered to produce respective substrates and enzymes. Single microbial cultures or mixed cultures may be used. N-acetylated oligosaccharide formation can be initiated by acceptor substrates starting from any degree of polymerisation (DP) from DP=1 onwards. Another option is the chemical conversion of keto-hexoses (e.g. fructose) either free or bound to an oligosaccharide (e.g. lactulose) into N-acetylhexosamine or an N-acetylhexosamine containing oligosaccharide as described in Wrodnigg, T. M.; Stutz, A. E. (1999) Angew. Chem. Int. Ed. 38:827-828.

Suitable galacto-oligosaccharides include Galβl,6Gal, Galβl,6Galβl,4Glc, Galβl,6Galβl,6Glc, Galβ1,3Galβ1,3Glc, Galβl,3Galβl,4Glc, Galβl,6Galβ1,6Galβ1,4Glc, Galβ1,6Galβ1,3Galβ1,4Glc, Galβ1,3Galβ1,6Galβ1,4Glc, Galβl, 3Galβl,3Galβl,4Glc, Galβl,4Galβl,4Glc and Galβl,4Galβl,4Galβl,4Glc.

Synthesised galacto-oligosaccharides such as Galβl,6Galβl, 4Glc, Galβl,6Galβl,6Glc, Galβl,3Galβl,4Glc, Galβl,6Galβl,6Galβl,4Glc, Galβl,6Galβl,3Galβl,4Glc and Galβl,3Galβl,6Galβl,4Glc, Galβl,4Galβl,4Glc and Galβl,4Galβl,4Galβl,4Glc and mixtures thereof are commercially available under the trademarks Vivinal® and Elix'or®. Other suppliers of oligosaccharides are Dextra Laboratories, Sigma-Aldrich Chemie GmbH and Kyowa Hakko Kogyo Co., Ltd. Alternatively, specific glycosyltransferases, such as galactosyltransferases may be used to produce neutral oligosaccharides.

Suitable sialylaled oligosaccharides include NeuAcα2,3Galβl,4Glc and NeuAcα2,6Galβl,4Glc. These sialylated oligosaccharides may be isolated by chromatographic or filtration technology from a natural source such as animal milks. Alternatively, they may also be produced by biotechnology using specific sialyltransferases either by enzyme based fermentation technology (recombinant or natural enzymes) or by microbial fermentation technology. In the latter case microbes may either express their natural enzymes and substrates or may be engineered to produce respective substrates and enzymes. Single microbial cultures or mixed cultures may be used. Sialyl-oligosaccharide formation can be initiated by acceptor substrates starting from any degree of polymerisation (DP) from DP=1 onwards.

In one embodiment the content (w/w %) in oligosaccharides and/or prebiotics is higher in the first infant formula than in the second infant formula. In one embodiment the content (w/w %) in oligosaccharides and/or prebiotics is higher in the second infant formula than in the optional third infant formula. In one specific embodiment the content (w/w %) in oligosaccharides and/or prebiotics is higher in the second infant formula than in the first and optional third infant formula. This corresponds to the phase of developments where the prebiotics and/or oligosaccharides play the most active role in the development of the body functions.

The first, second and third formulae may optionally contain other substances which may have a beneficial effect such as nucleotides, nucleosides, and the like. Nucleotides may be selected from cytidine monophosphate (CMP), uridine monophosphate (UMP), adenosine monophosphate (AMP), guanosine monophosphate (GMP) or any mixtures thereof.

Any of the first, second or third formulae may also comprise at least one probiotic bacterial strain.

Examples of suitable probiotic micro-organisms include yeasts such as Saccharomyces, Debaromyces, Candida, Pichia and Torulopsis, moulds such as Aspergillus, Rhizopus, Mucor, and Penicillium and Torulopsis and bacteria such as the genera Bifidobacterium, Bacteroides, Clostridium, Fusobacterium, Melissococcus, Propionibacterium, Streptococcus, Enterococcus, Lactococcus, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Saccharomyces cereviseae, Bacillus coagulans, Bacillus licheniformis, Bacillus subtilis, Bifidobacterium bifidum, Bifidobacterium infantis, Bifidobacterium longum, Enterococcus faecium, Enterococcus faecalis, Lactobacillus acidophilus, Lactobacillus alimentarius, Lactobacillus casei subsp. casei, Lactobacillus casei Shirota, Lactobacillus curvatus, Lactobacillus delbruckii subsp. lactis, Lactobacillus farciminus, Lactobacillus gasseri, Lactobacillus helveticus, Lactobacillus johnsonii, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophiles, Streptococcus faecalis, Streptococcus thermophilus, Staphylococcus carnosus, and Staphylococcus xylosus.

In an embodiment, probiotic bacterial strains include, but not being limited to, Lactobacillus rhamnosus ATCC 53103 obtainable from Valio Oy of Finland under the trade mark LGG, Lactobacillus rhamnosus CGMCC 1.3724, Lactobacillus paracasei CNCM 1-2116, Bifidobacterium lactis CNCM 1-3446 sold inter alia by the Christian Hansen company of Denmark under the trade mark Bb 12 and Bifidobacterium longum ATCC BAA-999 sold by Morinaga Milk Industry Co. Ltd. of Japan under the trade mark BB536.

The amount of probiotic, if present, is preferably present in an amount of 10³ to 10¹² cfu/g, more preferably 10⁶ to 10¹¹ cfu/g, even more preferably 10⁴ to 10⁹ cfu/g, most preferably 10² to 10⁹ cfu/g composition or per mL of composition. In a preferred embodiment, any of the nutritional formulae comprise 2×10⁷ cfu/g. Most preferably, the probiotic is Bifidobacterium lactis.

In an embodiment, the probiotics in the first and second infant formulae are selected from the list comprising L. helveticus CNCM I-4095, B. longum CNCM I-2618, B. breve NCC2950, L. paracasei ST11 CNCM I-2116, B. longum BB536 ATCC BAA-999, B. Longum BL999, L. acidophilus L92 FERM BP.4981 or any mixtures thereof, preferably in an amount of 10⁴-10⁷ cfu/g, most preferably 10⁶ cfu/g.

In another embodiment, the probiotics in the optional third infant formula are selected from the list comprising B. longum CNCM I-2618, B. breve CNCM I-3865, B. lactis CNCM I-3446, B. longum ATCC BAA-999 (Bb536), L. lactis SL31 CNCM I-4154, L. paracasei ST11 CNCM I-2116 or any mixtures thereof, preferably in an amount of 10⁶-10⁸ cfu/g, most preferably 10⁷ cfu/g.

In one embodiment the second infant formula comprises the probiotics to specifically address the infants colics and crying occurring at a peak within the corresponding period.

In the present invention, the infant formulae are preferably in the form of a powder to be reconstituted or concentrate to be diluted. The powder or concentrate can be reconstituted or diluted with water. The end product is thus preferably a liquid.

These infant formulae of the present invention may be prepared in any suitable manner. For example, an infant formula may be prepared by blending together a protein source, a carbohydrate source, and a fat source in appropriate proportions. If used, emulsifiers may be included in the blend. The vitamins and minerals may be added at this point but are usually added later to avoid thermal degradation. Any lipophilic vitamins, emulsifiers and the like may be dissolved into the fat source prior to blending. Water, preferably water which has been subjected to reverse osmosis, may then be mixed in to form a liquid mixture.

The liquid mixture may then be thermally treated to reduce bacterial loads. For example, the liquid mixture may be rapidly heated to a temperature in the range of about 80° C. to about 110° C. for about 5 seconds to about 5 minutes. This may be carried out by steam injection or by heat exchanger; for example a plate heat exchanger. The liquid mixture may then be cooled to about 60° C. to about 85° C. for example by flash cooling. The liquid mixture may then be homogenised for example in two stages at about 7 MPa to about 40 MPa in the first stage and about 2 MPa to about 14 MPa in the second stage. The homogenised mixture may then be further cooled to add any heat sensitive components such as vitamins and minerals. The pH and solids content of the homogenised mixture are conveniently standardised at this point.

The homogenised mixture is transferred to a suitable drying apparatus such as a spray drier or freeze drier and converted to powder. The powder should have a moisture content of less than about 3% by weight. Alternatively, the homogenized mixture is concentrated.

If it is desired to add probiotic(s), they may be cultured according to any suitable method and prepared for addition to the infant formula by freeze-drying or spray-drying for example. Alternatively, bacterial preparations can be bought from specialist suppliers such as Christian Hansen and Morinaga already prepared in a suitable form for addition to food products such as infant formula. Such bacterial preparations may be added to the powdered infant formula by dry mixing.

In an embodiment of the invention, the nutritional formulae are packed in single dose units, each unit comprising sufficient nutritional composition to prepare a single serving upon reconstitution with water. Preferably, the units are in the form of capsules or cans.

A single serving generally comprises 8 to 35 g, preferably 10 to 30 g, most preferably 11 to 28 g of powder to be reconstituted with 80 to 300 mL, preferably between 100 mL and 250 mL of water. Alternatively, if the nutritional composition is a concentrate, a single serving includes 1 to 50 mL of concentrate to be diluted with 50 to 250 mL of water.

The invention also pertains to an age-tailored kit for infants. The kit comprises an array of infant formulae as described herein. The infant formulae are packed in single dose units, each unit comprising sufficient nutritional composition to prepare a single serving upon reconstitution with water. Typically, the units comprise 10 to 30 g of powdered nutritional composition or 5 to 50 g of a concentrate of nutritional composition. Preferably the units are in the form of capsules. They may also be in the form of stick packs or sachets.

The capsules may be disposable capsules equipped with opening means contained within the capsule to permit draining of the reconstituted formula directly from the capsule into a receiving vessel such as a young child bottle. Such a method of using capsules for dispensing an infant nutritional composition is described in WO2006/077259. The different nutritional formulae forming part of the array of the invention may be packed into individual capsules and presented to the consumer in multipacks containing a sufficient number of capsules to meet the requirements of an infant for one week for example. Suitable capsule constructions are disclosed in WO2003/059778.

In summary, by modifying the contents of mineral nutrients in the infant formulae according to infant age, the array of age-tailored infant formulae of the present invention can provide optimum mineral nutrient contents which follow the nutritional evolution curve of human breast milk, thus is beneficial for the body development of an infant.

The mineral content is of particular importance at various age of the development of the infant. Each mineral can be related to a specific function or a group of functions. Each mineral (presence and % content) be correctly balanced with other minerals to insure the proper development of the infant.

The present invention is further illustrated hereinafter by means of the following non-limiting examples.

### EXAMPLES

### Example 1

An array of age-tailored infant formulae is given in the table below. For each formula, 13.08 g powder was added into 90 mL water to provide 100 mL reconstituted milk.

| | | Age range | | |
|---|---|---|---|---|
| | | 0 to 2 | 2 to 6 | 6 to 12 |
| | | months | months | months |
| Basics | Reconstitution | 100 to | 100 to | 230 |
| | RTD Volume | 200 | 200 | |
| | (ml) | | | |
| | Energy | 63- | 63- | 63 |
| | density | 67 | 67 | |
| | (kcal/100 ml) | | | |
| Protein | Content | 1.8- | 1.8- | 1.8 |
| | (g/100 kcal) | 2.25 | 2.25 | |
| | Content (g/l) | 11.3- | 11.3- | 11.3 |
| | | 15.1 | 15.1 | |
| | Whey:Casein | 70:30 | 70:30 | 50:50 |
| | Functional | . | . | |
| | proteins | | | |
| Carbo- | Type | Lactose | Lactose | Lactose |
| hydrates | Content | 9.7 to | 9.7 to | 10.6 |
| | (g/100 kcal) | 11.6 | 11.6 | |
| | Content (g/l) | 65.0 to | 65.0 to | 66.8 |
| | | 73.5 | 73.5 | |
| Lipids | Type | Milk & | Milk & | Milk & |
| | | Veg. | Veg. | Veg. |
| | Content | 5.1 to | 5.1 to | 5.6 |
| | (g/100 kcal) | 5.8 | 5.8 | |
| | content (as % | 45.9 to | 45.9 to | 45.8 |
| | of total | 52.2 | 52.2 | |
| | energy) | | | |
| | Content (g/l) | 32.1 to | 32.1 to | 35.3 |
| | | 38.9 | 38.9 | |
| | LC-PUFA | DHA + | DHA + | DHA + |
| | | ARA | ARA | ARA |
| Soluble | Content | | | |
| Fibers | (g/100 kcal) | | | |
| Probiotics | Type | B. lactis | B. lactis | |
| | | | or | |
| | | | B. Longum | |
| | Content | 2 × 10⁷ cfu/g | 2 × 10⁷ cfu/g | |
| | | | or 10⁸ cfu/g | |
| Nucleo- | CMP | 1.1 | 1.1 | — |
| tides | (mg/100 kcal) | | | |
| | UMP | 0.7 | 0.7 | — |
| | AMP | 0.7 | 0.7 | — |
| | GMP | 0.2 | 0.2 | — |
| | NucleoPremix | | | — |
| Minerals | Na (mg) | 40 | 24 | 21 |
| (/100 kcal) | K (mg) | 105 | 81 | 70 |
| | Na/K (molar | 0.65 | 0.5 | 0.5 |
| | ratio) | | | |
| | (Na + K)/Cl | 1.71 to | 1.71 to | 1.71 |
| | molar ratio | 1.81 | 1.81 | |
| | Cl (mg) | 87 to | 61 to | 56 |
| | | 92 | 65 | |
| | Ca (mg) | 100 | 97 | 90 |
| | P (mg) | 47 | 42 | 37 |
| | Mg (mg) | 7 | 7 | 7 |
| | Mn (μg) | 5 | 5 | 5 |
| | Ca/P | 2.13 | 2.31 | 2.43 |
| | Fe (mg) | 0.7 | 0.7 | 1 |
| | I (μg) | 25 | 15 | 13 |
| | Cu (μg) | 100 | 60 | 53 |
| | Zn (mg) | 1.2 | 0.65 | 0.55 |
| | Se (μg) | 3 to | 3 to | 3 |
| | | 4 | 4 | |
| | F (μg) | | | — |
| Vitamins | Vit. A | 0.09 to | 0.09 to | 0.09 |
| (/100 kcal) | (mg RE) | 0.1125 | 0.1125 | |
| | Beta carotene | | | |
| | (μg) | | | |
| | Vit. D (mg) | 0.0015 | 0.0015 | 0.0015 |
| | Vit. E (mg) | 1.3 | 1.3 | 1.3 |
| | Vit. K1 (μg) | 8 | 8 | 8 |
| | Vit. C (mg) | 15 | 15 | 15 |
| | Vit. B1 (mg) | 0.07 to | 0.07 to | 0.1 |
| | | 0.1 | 0.1 | |
| | Vit. B2 (mg) | 0.1 | 0.1 | 0.1 |
| | Niacin (mg) | 0.5 | 0.5 | 0.5 |
| | Vit. B6 (mg) | 0.05 | 0.05 | 0.05 |
| | Folic acid | 15 to | 15 to | 15 |
| | (μg) | 16 | 16 | |
| | Pantothenic | 0.7 to | 0.7 to | 0.8 |
| | Acid (mg) | 0.8 | 0.8 | |
| | Vit. B12 (μg) | 0.2 | 0.2 | 0.2 |
| | Biotin (μg) | 2 | 2 | 2 |
| | Choline (mg) | 20 | 20 | 20 |
| | Inositol (mg) | 25 | 25 | 20 |
| | Taurine (mg) | 8 | 8 | 6 |
| | Carnitine | 1.5 | 1.5 | — |
| | (mg) | | | |

### Example 2

An array of age-tailored infant formulae is given in the table below:

| | 0 to 2 | 2 to 6 | 6 to 12 |
|---|---|---|---|
| | months | months | months |
| Nutrient | per 100 kcal | per 100 kcal | per 100 kcal |
| Energy (kcal) | 100 | 100 | 100 |
| Protein (g) | 1.83 | 1.83 | 1.83 |
| Fat (g) | 5.3 | 5.3 | 5.3 |
| Linoleic acid (g) | 0.79 | 0.79 | 0.79 |
| α-Linolenic acid | 101 | 101 | 101 |
| (mg) | | | |
| Lactose (g) | 11.2 | 11.2 | 11.2 |
| Minerals (g) | 0.37 | 0.37 | 0.37 |
| Na (mg) | 40 | 23 | 21 |
| K (mg) | 100 | 80 | 75 |
| Cl (mg) | 64 | 64 | 64 |
| Ca (mg) | 100 | 96 | 92 |
| P (mg) | 46 | 41 | 37 |
| Ca/P ratio | 2.17 | 2.34 | 2.48 |
| Mg (mg) | 7 | 7 | 7 |
| Mn (μg) | 8 | 8 | 8 |
| Se (μg) | 2 | 2 | 2 |
| Vitamin A (μg RE) | 105 | 105 | 105 |
| Vitamin D (μg) | 1.5 | 1.5 | 1.5 |
| Vitamin E (mg TE) | 0.8 | 0.8 | 0.8 |
| Vitamin K1 (μg) | 8 | 8 | 8 |
| Vitamin C (mg) | 10 | 10 | 10 |
| Vitamin B1 (mg) | 0.07 | 0.07 | 0.07 |
| Vitamin B2 (mg) | 0.15 | 0.15 | 0.15 |
| Niacin (mg) | 1 | 1 | 1 |
| Vitamin B6 (mg) | 0.075 | 0.075 | 0.075 |
| Folic acid (μg) | 9 | 9 | 9 |
| Pantothenic acid | 0.45 | 0.45 | 0.45 |
| (mg) | | | |
| Vitamin B12 (μg) | 0.3 | 0.3 | 0.3 |
| Biotin (μg) | 2.2 | 2.2 | 2.2 |
| Choline (mg) | 10 | 10 | 10 |
| Fe (mg) | 1.2 | 1.2 | 1.2 |
| I (μg) | 24 | 15 | 13 |
| Cu (μg) | 95 | 60 | 54 |
| Zn (mg) | 1.25 | 0.65 | 0.58 |
| 3′ sialyllactose | 30 | 30 | 30 |
| (mg) | | | |
| 6′ sialyllactose | 6 | 6 | 6 |
| (mg) | | | |
| LNnT (mg) | 30 | 30 | 30 |
| 2FL (g) | 0.3 | 0.3 | 0.3 |

1. An array of infant formula for providing an age-tailored nutrition system to an infant, comprising a first infant formula and a second infant formula, wherein
the first infant formula being designed to meet the nutritional requirements of an infant from birth to two months,
the second infant formula being designed to meet the nutritional requirements of an infant from two months to six months, and
wherein each of the first and second infant formula comprises suitable amounts of mineral nutrients selected from the group consisting of calcium, iodine, phosphorus, potassium, sodium, copper and zinc,
wherein the content of at least one of the mineral nutrients in the second infant formula is lower than in the first infant formula.

2. The array of infant formula according to claim 1, wherein the contents of at least two of the mineral nutrients in the second infant formula are lower than in the first infant formula.

3. The array of infant formula according to claim 1, wherein the contents of iodine, phosphorus, potassium, sodium, copper and zinc in the second infant formula are lower than in the first infant formula.

4. The array of infant formula according to claim 1, wherein the contents of calcium, iodine, phosphorus, potassium, sodium, copper and zinc in the second infant formula are lower than in the first infant formula.

5. The array of infant formula according to claim 1, wherein the content of iodine in the first infant formula is from 50.0 μg/100 kcal to 16.5 μg/100 kcal, and the content of iodine in the second infant formula is from 16.5 μg/100 kcal to 14.0 μg/100 kcal.

6. The array of infant formula according to claim 1, wherein the content of phosphorus in the first infant formula is from 70 mg/100 kcal to 42 mg/100 kcal, and the content of phosphorus in the second infant formula is from 42 mg/100 kcal to 38 mg/100 kcal.

7. The array of infant formula according to claim 1, wherein the content of potassium in the first infant formula is from 170 mg/100 kcal to 85 mg/100 kcal, and the content of potassium in the second infant formula is from 85 mg/100 kcal to 80 mg/100 kcal.

8. The array of infant formula according to claim 1, wherein the content of sodium in the first infant formula is from 58 mg/100 kcal to 25 mg/100 kcal, and the content of sodium in the second infant formula is from 25 mg/100 kcal to 22 mg/100 kcal.

9. The array of infant formula according to claim 1, wherein the content of copper in the first infant formula is from 120 μg/100 kcal to 62 μg/100 kcal, and the content of copper in the second infant formula is from 62 μg/100 kcal to 55 μg/100 kcal.

10. The array of infant formula according to claim 1, wherein the content of zinc in the first infant formula is from 1.5 mg/100 kcal to 0.7 mg/100 kcal, and the content of zinc in the second infant formula is from 0.7 mg/100 kcal to 0.6 mg/100 kcal.

11. The array of infant formula according to claim 1, wherein the content of calcium in the first infant formula is from 140 mg/100 kcal to 98 mg/100 kcal, and the content of calcium in the second infant formula is from 98 mg/100 kcal to 95 mg/100 kcal.

12. The array of infant formula according to claim 1, wherein the ratio of calcium and phosphorus in the first infant formula is lower than in the second infant formula.

13. The array of infant formula according to claim 1, wherein the ratio of calcium and phosphorus in the first infant formula is from 2.0:1 to 2.2:1.

14. The array of infant formula according to claim 1, wherein the ratio of calcium and phosphorus in the second infant formula is from 2.2:1 to 2.4:1.

15. The array of infant formula according to claim 1, wherein the ratio of calcium and phosphorus in the third infant formula is from 2.4:1 to 2.5:1.

16. The array of infant formula according to claim 1, wherein each of the first and the second infant formula comprises an ingredient selected from the group consisting of vitamins, lactoferrin, probiotics, prebiotics, proteins associated with milk fat globule membrane (MFGM), hydrolysed or non-hydrolysed protein, carbohydrates, maltodextrin, and mixtures thereof.

17. The array of infant formula according to claim 16, wherein the probiotics in the first and second infant formulae are selected from the group consisting of L. helveticus CNCM I-4095, B. longum CNCM I-2618, B. breve NCC2950, L. paracasei ST11 CNCM I-2116, B. longum BB536 ATCC BAA-999, B. Longum BL999, L. acidophilus L92 FERM BP.4981 and mixtures thereof.

18. The array of infant formula according to claim 27, wherein the third infant formula includes probiotics selected from the group consisting of B. longum CNCM I-2618, B. breve CNCM I-3865, B. lactis CNCM I-3446, B. longum ATCC BAA-999 (Bb536), L. lactis SL31 CNCM I-4154, L. paracasei ST11 CNCM I-2116 and mixtures thereof.

19. The array of infant formula according to claim 1, wherein each of the first and the second formula comprises long-chain polyunsaturated fatty acids, and/or medium-chain triglycerides and/or milk fat globule membranes (MFGM), and mixtures thereof.

20. The array of infant formula according to claim 1, wherein the first infant formula has a protein source comprising whey having a protein content between 2.0 and 3.0 g protein/100 kcal, and the second infant formula has a protein source comprising whey and casein proteins and has a whey:casein ratio between 70:30 and 50:50 and a protein content between 1.7 and 2.1 g protein/100 kcal with the proviso that either the protein content or the whey:casein ratio of the second formula or both is/are lower than for the first formula.

21. The array of infant formula according to claim 1, wherein each of the first and the second formula are in the form of a powder to be reconstituted or a concentrate to be diluted.

22. The array of infant formula according to claim 1, wherein the first and the second formula are packed in single dose units, each unit comprising sufficient nutritional composition to prepare a single serving upon reconstitution with water.

23. The array of infant formula according to claim 1, wherein the single dose units are in a form of a capsule or a can.

24. A method for improving the nutritional condition of an infant from birth to twelve months comprising administering to the infant an array of infant formula for providing an age-tailored nutrition system to an infant, comprising a first infant formula and a second infant formula, wherein
the first infant formula being designed to meet the nutritional requirements of an infant from birth to two months,
the second infant formula being designed to meet the nutritional requirements of an infant from two months to six months, and
wherein each of the first and second infant formula comprises suitable amounts of mineral nutrients selected from the group consisting of calcium, iodine, phosphorus, potassium, sodium, copper and zinc,
wherein the content of at least one of the mineral nutrients in the second infant formula is lower than in the first infant formula.

25. (canceled)

26. A method of providing nutrition to an infant, comprising:
feeding to the infant for initial two months of life a first infant formula and then a second infant formula
wherein each of the first and second infant formula comprises suitable amounts of mineral nutrients selected from the group consisting of calcium, iodine, phosphorus, potassium, sodium, copper and zinc,
wherein the content of at least one of the mineral nutrients in the second infant formula is lower than in the first infant formula; and
feeding to the infant for the remainder of the first six months of life the second infant formula.

27. An array of infant formula for providing an age-tailored nutrition system to an infant, comprising a first infant formula, a second infant formula and a third infant formula, wherein
the first infant formula being designed to meet the nutritional requirements of an infant from birth to two months;
the second infant formula being designed to meet the nutritional requirements of an infant from two months to six months; and
the third infant formula being designed to meet the nutritional requirements of an infant from six months to twelve months;
wherein each of said first, second and third infant formula comprises suitable amounts of mineral nutrients selected from the group consisting of calcium, iodine, phosphorus, potassium, sodium, copper and zinc; and
wherein the content of at least one of the mineral nutrients in the second infant formula is lower than in the first infant formula, and the content of the at least one mineral nutrient in the third infant formula is lower than in the second infant formula.

28. The array of infant formula according to claim 27, wherein the contents of at least two of the mineral nutrients in the second infant formula are lower than in the first infant formula, and the contents of the at least two mineral nutrients in the third infant formula are lower than in the second infant formula.
